(19) United States
(12) Patent Application Publication
(10) Pub. No.: US 2008/0237198 A1
(43) Pub. Date: Oct. 2, 2008

(54) SPIKE RESISTANCE SPOT WELDING SYSTEM AND METHOD

(75) Inventor: Paul C. Edwards, Marysville, OH (US)

Correspondence Address: STANDLEY LAW GROUP LLP, 495 METRO PLACE SOUTH, SUITE 210, DUBLIN, OH, 43017, US

(73) Assignee: Honda Motor Co., Ltd., Tokyo (JP)

(21) Appl. No.: 11/692,593

(22) Filed: Mar. 28, 2007

(51) Int. Cl. B23K 11/11

(52) U.S. Cl. 219/86.33

(57) ABSTRACT

A system and method for performing one-sided spot welding on parts to be welded. The system uses a spot welding device that transfers electric welding current through a consumable welding spike to a localized spot on the parts to be welded. The welding spike is pressed against a surface of the parts to be welded by a weld electrode during the spot welding process. The consumable welding spike is preferably melted and absorbed into the melt pool produced by the electric welding current.

### BACKGROUND OF THE INVENTIVE FIELD

The present invention is directed to one-sided spot welding. More particularly, the present invention is directed to a system and method that utilizes consumable weld spikes to facilitate spot welding from a single side.

Typical spot welding is a widely used and widely recognized technique for joining various metallic sheet metal parts. More specifically, spot welding is a resistance welding technique that operates by applying welding current and clamping force to a small area (“spot”) of the parts to be welded. By so concentrating the welding current and force, heat generated by the welding current quickly melts the parts at the welding spot—rendering them joined upon removal of the welding current and a cooling of the parts.

Spot welding not only requires sufficient current to melt the materials to be joined, but also requires that sufficient pressure be exerted to maintain contact between the parts at the welding spot during the application of the welding current. To this end, various spot welding devices have been designed and used over the years. Probably the most common type of spot welding device is a multi-axis welding robot equipped with a spot welding gun, but others also exist. The spot welding gun commonly comprises two gun arms between which the parts to be welded are clamped during welding. Clamping pressure is commonly provided by moving one or both the gun arms around a pivot axis by means of a pneumatic, electric or hydraulic cylinder.

The welding end of each gun arm is provided with a weld electrode that is in contact with a respective side of the parts to be joined when the weld gun is in a welding position with respect thereto. In operation, electric current is passed from one weld electrode to the other—through the parts to be welded. Resistance to the transfer of electric current causes a buildup of heat, which temporarily melts the parts at the welding spot and leads to their joinder upon cooling.

Clamping force is also transferred from the gun arms to the parts through the weld electrodes. In typical spot welding techniques, clamping force is applied to the parts to welded from both sides, thereby pinching the parts between the weld electrodes. Depending on the material composition and thicknesses of the parts to be welded, typical spot welding clamping forces can be 350 kgf or higher.

It is well known that spot welding is widely used in the assembly of vehicles, such as automobiles. For example, spot welding is commonly employed to join various sections of an automobile body (e.g., side panels to a roof panel, etc.) In modern automobile construction, spot welding is also used to create “stack-ups” of sheet metal panels. Stack-ups are generally areas of body panels (e.g., door panels) where two or more pieces of sheet metal are stacked together and welded to produce reinforced areas in the resulting automobile body. The materials used in such stack-ups are often of dissimilar thickness and/or composition.

It can be readily understood by one skilled in the art that automobile bodies and other products that are manufactured using spot welding are often of complex shape. It can also be readily understood by one skilled in the art that the shape, size, and or orientation of certain components during manufacture can make it difficult if not impossible to properly locate a spot weld gun thereto. Further, the creation of stack-ups and other spot welding operations that require the insertion of a welding gun arm into the interior of a vehicle body or other structure also pose problems of access when using traditional spot welding techniques.

As a result of the foregoing problems, a considerable interest has developed in one-sided spot welding—that is, spot welding where the electric welding current is passed through the parts to be welded from only a single side. While the ability to perform one-sided spot welding is desirable, the ability to perform such welding has proven problematic.

First, it is difficult with known one-sided spot welding devices and techniques to generate sufficient melting of the parts to be welded at the weld spot. This is due largely to an inability to acceptably focus the welding current without the presence of a second weld electrode. It has been suggested to alleviate this problem by placing a secondary weld enhancing material between the parts to be welded, and at each location to be welded. This secondary material may be in the shape of a ring that surrounds the weld spot, for example.

Even if such a welding technique actually works, a fact of which Applicant has no knowledge, there are obvious drawbacks to its use. First, it would be required to locate a secondary material between all parts to be welded—and at each and every location that spot welding is to take place. As would be understood by one skilled in the art, such a technique would be extremely time consuming with respect to parts (e.g., vehicle body panels) receiving a large number of spot welds. Further, because the secondary material is associated with the parts to be welded, and not a welding device, a means of at least temporary affixation of the secondary material to one or both of the parts to be welded must be provided. Without such an affixation means, there can be no guarantee that the secondary material will be properly located at the time of welding.

Obviously, even if functional, this is not a welding technique that can be practically used in most manufacturing processes. Having to locate a secondary material at every intended spot weld location across large panels or similar parts is simply not practical—both due to the time required for location and because of the possibility that one or more of said secondary materials might become dislodged prior to welding, thereby resulting in a defective part.

Known one-sided spot welding devices and techniques also suffer from an additional problem related to applying a clamping force during welding from only one side. More specifically, the clamping force exerted on the parts during known one-sided spot welding processes must remain relatively high. Consequently, with no clamping force pushing back from an opposite side of the parts, as occurs in traditional two-sided spot welding, deformation of the parts to be welded is possible. More specifically, the amount of force that must be exerted by the weld electrode against one-side of the parts to be welded can be sufficient to deform the parts in and around the various weld points. Clearly, such deformations would be generally unacceptable.

Therefore, an improved method of performing one-sided spot welding without the aforementioned drawbacks and a device for performing such spot welding is needed. The device and method of the present invention satisfies this need.

### SUMMARY OF THE GENERAL INVENTIVE CONCEPT

A one-sided spot welding system and method of the present invention allows for the performance of one-sided spot welding without any of the aforementioned drawbacks. A one-sided spot welding method of the present invention makes use of consumable welding spikes that are located between the weld electrode and the parts to be welded prior to introduction of the welding current.

Depending on the specific spot weld to be produced and the materials to be joined, the consumable welding spikes may be of various material composition, shape, and size. In any event, however, the consumable welding spikes preferably act to increase resistance to the passage of the welding current and, therefore, allow for a greater generation of heat and a melting of the parts to be joined at the welding spot. Because the consumable welding spikes increase resistance to the passage of the welding current, an acceptable one-sided spot weld can also be produced with less clamping force exerted on the parts to be welded. The consumable welding spikes are generally fully melted and absorbed into the melt pool that is generated during the welding process.

A device for performing one-sided spot welding using consumable welding spikes is preferably equipped with an automatic feeding mechanism that supplies a consumable welding spike to the tip of a weld electrode prior to the performance of each spot weld. Various commercially available feeding systems are available that can be adapted to perform this function.

Therefore, a one-sided spot welding system and method of the present invention allows for the creation of high quality one-sided spot welds. A system and method of the present invention allows for the performance of one-sided spot welding without the need to locate and affix a secondary weld-enhancing material between the parts to be welded at every spot weld location. A system and method of the present invention also allows for the performance of one-sided spot welding with less clamping force exerted on the parts to be welded—thereby minimizing or eliminating the likelihood that the parts will be deformed during the welding process.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a portion of a typical two-sided spot welding device being used to spot weld two sheets of material;

FIG. 2 depicts a known one-sided spot welding process, wherein a single welding electrode is used to spot weld two sheets of material from a single side;

FIG. 3 represents the general concept of the present invention, wherein the spot welding of two sheets of material is being performed using a welding spike;

FIG. 4 is a partial cut-away view showing one exemplary embodiment of a one-sided spot welding system of the present invention;

FIG. 5 depicts one exemplary embodiment of a consumable welding spike feeding system of the present invention; and

FIG. 6 illustrates another exemplary embodiment of a consumable welding spike feeding system of the present invention.

### DETAILED DESCRIPTION OF EXEMPLARY EMBODIMENT(S)

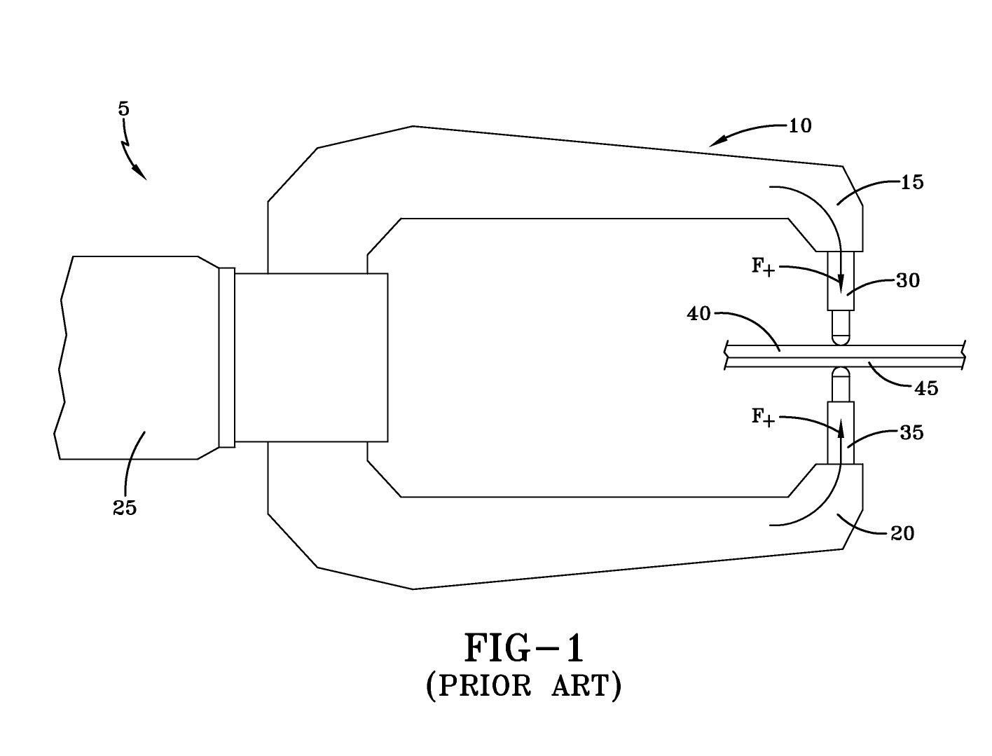

A portion of a typical two-sided spot welding device 5 can be observed by reference to FIG. 1. As shown, a spot welding gun 10 comprising first and second gun arms 15, 20 is connected to the arm of a multi-axis robot 25. The welding end of each gun arm 15, 20 is provided with an associated weld electrode 30, 35. The weld electrodes 30, 35 are shown in a welding position, wherein they are in contact with associated first and second sheet materials 40, 45 that are to be spot welded together.

The welding gun 10, via the gun arms 15, 20 and weld electrodes 30, 35, exerts a clamping force F₊ from both sides of the sheets of material 40, 45. The clamping force is typically produced by a clamping cylinder (not shown) that pivots one or both of the gun arms around a fixed axis. With the welding gun 10 in the welding position, a welding current is passed from one electrode to the other through the sheets of material 40, 45, thereby creating a spot weld as previously described.

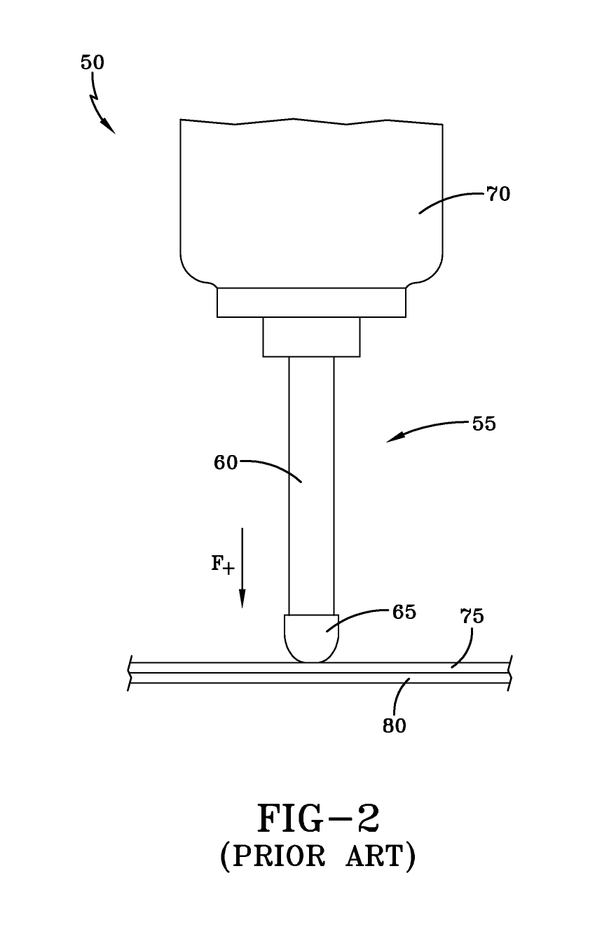

A portion of a typical one-sided spot welding device 50 is shown in FIG. 2. As can be seen in the portion shown, a spot welding gun 55 includes a welding shank 60 for receiving a weld electrode. A weld electrode 65 resides at the distal end of the shank 60. The spot welding gun 55 is attached to the arm of a multi-axis robot 70. The welding device 50 is shown in a welding position with the weld electrode 65 in contact with one of a first and second sheet of material 75, 80 that are to be spot welded together.

The welding gun 55, via the welding shank 60 and weld electrode 65, exerts a clamping force F₊ against one side of the sheets of material 75, 80. With the welding gun 55 in the welding position, a welding current is passed from the electrode 65 to the sheets of material 75, 80. Subject to the problem of providing sufficient resistance to the welding current, a spot weld is hopefully created as previously described. It can also be observed in FIG. 2 that depending on the magnitude of the clamping force F₊, the sheets of material 75, 80 can be easily deformed by the electrode 65.

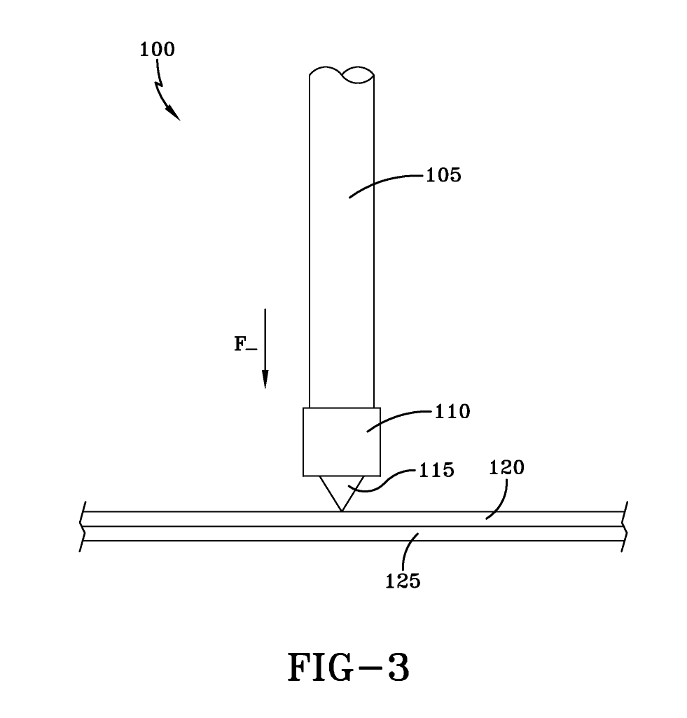

The general concept of the present invention can be understood by reference to FIG. 3. As shown, a portion of a one-sided spot welding device 100 of the present invention is being used in conjunction with a consumable welding spike 115 to effectuate one-sided spot welding of two sheets of material 120, 125. The one-sided spot welding device 100, which is described in more detail below, can be seen to include a shank 105 or a similar electrode holder. A weld electrode 110 is attached to the shank 105 at its distal end. The shank 105 directs welding current to the electrode 110, and may also include a cooling passage(s) for directing cooling fluid to the electrode (a well known technique in the welding art). A consumable welding spike 115 resides between the weld electrode 110 and the first sheet of material 120. A clamping force F₋ is exerted on the consumable welding spike 115 by the weld electrode 110.

In the exemplary embodiment of FIG. 3, the consumable welding spike 115 is shown to be conical in shape, with a base diameter of approximately 8 mm and a height of approximately 6 mm. However, it is to be understood that a consumable welding spike 115 of the present invention may be of virtually any size and shape, which size and/or shape may be determined by the materials to be welded and/or various parameters of the welding device 100. Thus, the term “spike,” as used herein, refers simply to a consumable welding material element—and is not limited to any particular size and/or shape.

Whatever the size and/or shape of a consumable welding spike 115 of the present invention, it is preferably constructed of a material that increases resistance to the passage of welding current during the spot welding process. As with the characteristics of size and shape, the composition of a consumable welding spike 115 of the present invention may be based on the composition of one or more of the materials being welded and/or various parameters of the welding device 100. However, it has been found that a consumable welding spike 115 of a given material can generally be used to spot weld sheets of material having similar, or dissimilar, composition, thickness and/or other physical properties. For example only, and without limitation, a consumable welding spike 115 of common 1006 carbon steel may be used to spot weld a sheet of plain carbon steel to a sheet of higher strength transformation induced plasticity (TRIP) steel. Other combinations are obviously also possible.

The clamping force F₋ exerted on the consumable welding spike 115 assures that it will not move during the spot welding process. The clamping force F₋ is also sufficient to maintain contact between the sheets of material 120, 125. However, due to the increased resistance to welding current passage created by the consumable welding spike 115, the clamping force F₋ required by the present invention is of considerably lesser magnitude than the clamping force F₊ required by typical two-sided and known one-sided spot welding processes. For example, in the exemplary embodiment of the invention shown in FIG. 3, the clamping force is between only about 25-100 kgf (although other clamping forces above and below this range are also possible). As such, deformation of the parts to be welded is minimized or eliminated.

During the spot welding process of the present invention, passage of welding current through the consumable welding spike 115 and the sheets of material 120, 125 produces sufficient heat generation to create a localized melt pool at the welding spot. This heat also melts the consumable welding spike 115, which is preferably absorbed into the melt pool and becomes part of the spot weld upon cooling of the parts.

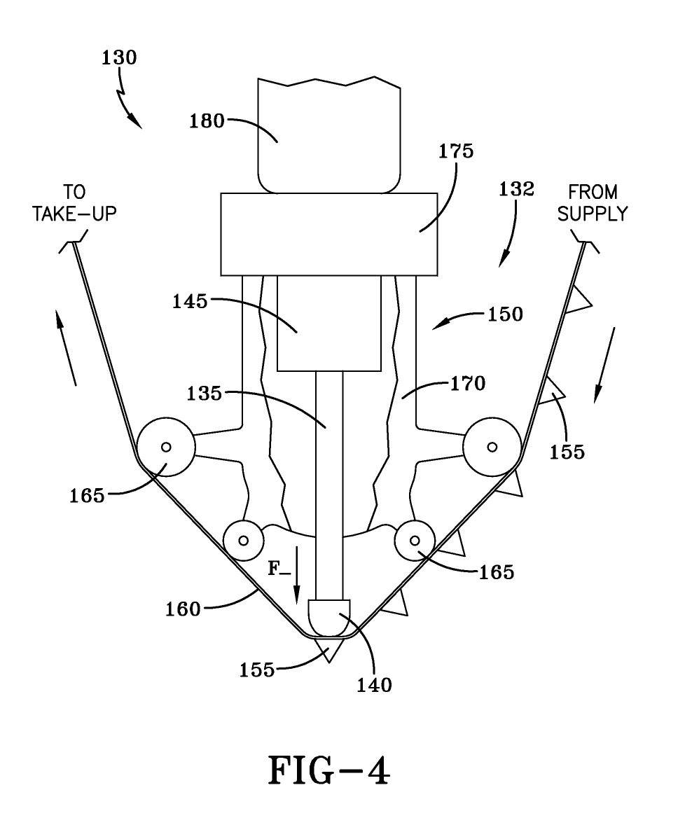

A more complete embodiment of a one-sided spot welding system 130 of the present invention is depicted in FIG. 4. In this embodiment, a welding device 132 is again shown to employ a shank 135 having a weld electrode 140 attached to its distal end. The proximal end of the shank 135 is preferably, but not necessarily, associated with a force regulator 145 that is operable to control the amount of force exerted by the weld electrode 140 on the parts to be welded.

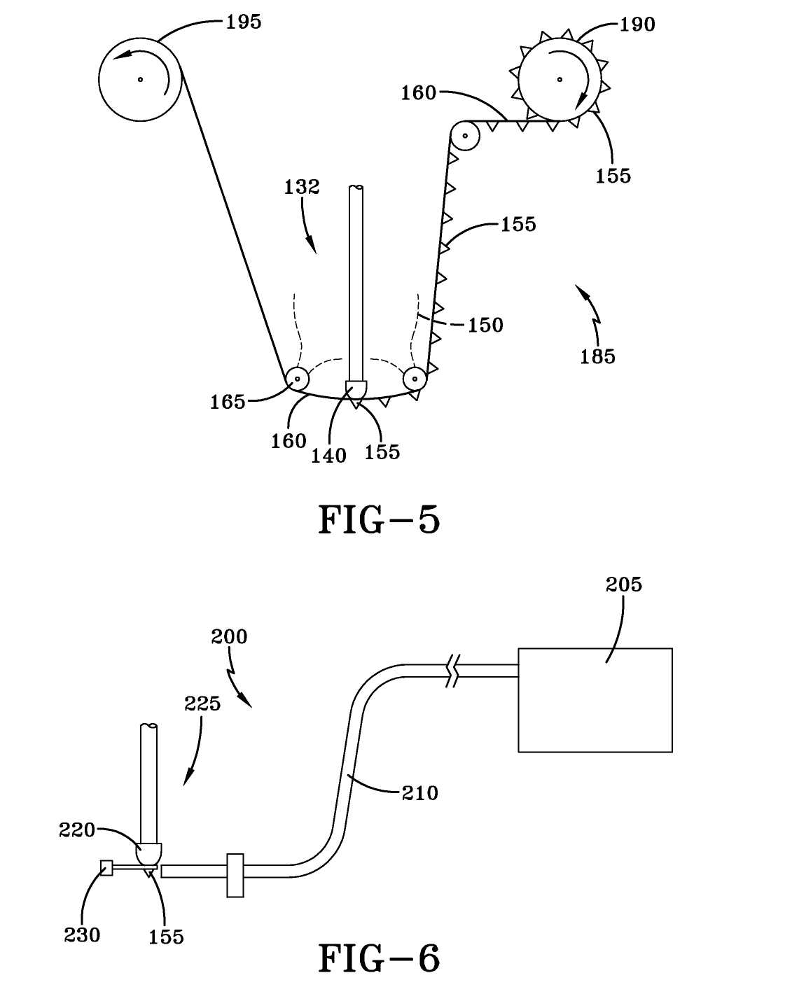

The welding system 130 also includes a consumable welding spike feeder 150. In this particular embodiment, the consumable welding spike feeder 150 is designed for use with a band feeder system (see FIG. 5) that supplies consumable welding spikes 155 to the welding device 132 on carrier bands 160. To this end, the consumable welding spike feeder 150 includes several rollers 165 mounted to a feeding jig 170. In conjunction with the remainder of the band feeder system, the rollers 165 act to direct the carrier bands 160 in front of the weld electrode 140, such that a consumable welding spike 155 is available for each spot weld to be performed.

The assembly of the shank 135, weld electrode 140, force regulator 145 and consumable welding spike feeder 150 is preferably attached to a mounting plate 175 that is operable to mount the assembly to the arm of a robot, preferably a multi-axis robot 180. Depending on the application, the welding device assembly could also be moved by a more simplistic one, two, three, etc., axis actuating apparatus, such as a 2-axis robot gantry or one or more actuating cylinders. In any event, the mounting plate 175 may be associated with a tool changer (not shown) to allow the robot or other moving means to quickly change between multiple welding device assemblies.

The force regulator 145 may employ pneumatic or electric operation, as would be understood by one skilled in the art. When the robot 180 is used to supply the clamping force F₋ to the parts to be welded, readings from the force regulator 145 may be fed back to the robot in order to adjust the magnitude of the clamping force applied, or the force regulator may be a part of the robot itself. Alternatively, the force regulator 145 may be a part of a dynamic device, such as an electric, pneumatic or hydraulic cylinder that extends the shank 135 and weld electrode 140 to provide the required clamping force F₋ during welding. In such an embodiment, the robot 180 may contribute to the clamping force F₋, or the entirety of the clamping force may be generated by the cylinder.

A band feeder system 185 that can be used to supply consumable welding spikes to a welding device and process of the present invention is schematically represented in FIG. 5. In conjunction with reference to FIG. 4, it can be understood that consumable welding spikes 155 are attached to a carrier band 160 for supply to a welding device 132 of the present invention. As shown, the carrier band 160 of consumable welding spikes 155 may be supplied from a feeder roll 190. The carrier band 160 is guided past the weld electrode 140 of the welding device 132 by the rollers 165 of the consumable welding spike feeder 150, as shown in FIG. 4. The carrier band 160 is advanced by the band feeder system 185 so that a consumable welding spike is presented to the weld electrode 140 at some point prior to commencement of each actual welding operation.

In one version of the band feeder system 185, electric welding current initially passes through the carrier band 160 and attached consumable welding spike 155 after the welding spike is presented to the weld electrode 140. More particularly, the carrier band 160 is manufactured from a conducting material in this embodiment. As such, there is a partial ground from the electrode 140 through the welding spike 155 and to the carrier band 160. As electric current is introduced by the weld electrode 140, a small amount of metal holding the welding spike 155 to the carrier band 160 acts like a fuse. That is, the electric current will melt the small amount of metal holding the welding spike 155 to the carrier band 160, thereby releasing the welding spike from the carrier band and creating a short. Subsequent to occurrence of the short, the electric current will automatically flow through the welding spike 155 and through the parts to be welded—melting the welding spike in the process of effecting a spot weld. The emptied carrier band 160 is preferably collected on a take-up roller 195 or similar device.

Alternatively, the carrier band 160 may be made from a non-conducting or substantially non-conducting material. In this case, the welding spikes 155 are removed from the carrier band 160 prior to their presentation to the weld electrode 140. The emptied carrier band 160 is preferably collected on a take-up roller 195 or similar device.

An alternate embodiment of a consumable welding spike feeding system that can be used with a one-sided spot welding device and method of the present invention can be seen in FIG. 6. This mechanical feeder system 200 makes use of a vibratory bowl 205 containing consumable welding spikes, to which is attached a feed tube 210 that leads to the weld electrode 220 of a one-sided spot welding device 225 of the present invention. The combination of a vibratory bowl and feed tube is a well known component supply method. Such systems are widely commercially available. As such, one skilled in the art would also understand the various techniques available with respect to such systems for ensuring delivery of the consumable welding spikes in a proper orientation.

Once delivered to the weld electrode 220, the consumable welding spike 155 is engaged by a spring-loaded catcher 230 that encapsulates an upper portion of the welding spike and holds it against the electrode 140. The spring-loaded catcher 230 may be mechanically or pneumatically operated. When the electrode 140 subsequently extends to and contacts the welding spike 155 against the parts to be welded, a catch mechanism associated with the spring-loaded catcher 230 is released, allowing the electrode to subsequently hold the welding spike against the parts. As previously described, the welding spike 155 is then consumed during the welding process. Feeder systems employing such spring-loaded catcher mechanisms would be well known to those skilled in the art.

While two exemplary embodiments of weld spike feeding systems are generally described above for purposes of illustration, it should be realized that a one-sided spot welding system and method of the present invention can make use of a variety of known, or as yet unknown, feeding systems. As such, a welding system of the present invention can be adapted as necessary to provide consumable welding spikes to the welding process, and nothing herein should be interpreted to limit the scope of a welding device or method of the present invention to use with a specifically shown or described consumable welding spike feeding system. Useable and/or modifiable feeding systems are available from various suppliers, such as the FastFeed Corporation in Lodi, Ohio, and Dengensha America in Bedford, Ohio. One skilled in the art would understand how to use or modify such feeding systems with respect to the present invention.

From the foregoing, it can be understood that a system and method of the present invention allows for successful automated one-sided spot welding of materials. The use of consumable welding spikes of different size, shape and/or composition allows one-sided spot welding to be successfully practiced on materials of similar or dissimilar thickness and similar or dissimilar composition. As can also be understood from the previous discussion, various iterations of a one-sided spot welding device are possible while still falling within the scope of the present invention.

Therefore, while certain embodiments of the present invention are described in detail above, the scope of the invention is not to be considered limited by such disclosure, and modifications are possible without departing from the spirit of the invention as evidenced by the following claims:

What is claimed is:

1. A system for performing one-sided spot welding on parts to be welded, comprising:
a spot welding device, further comprising at least:
an electrode holder, and
a weld electrode attached to said electrode holder and in communication with a source of electric welding current;
a means for moving said welding device to each location along said parts to be welded that requires a spot weld;
a supply of consumable welding spikes; and
a feeding system for supplying a consumable welding spike to said spot welding device;
wherein a consumable welding spike is located between said weld electrode and a surface of one of said parts to be welded prior to commencement of each spot weld.

2. The system of claim 1, further comprising a force regulator for regulating the amount of force exerted by said weld electrode against said parts to be welded.

3. The system of claim 1, wherein said means for moving said spot welding device to each location along said parts to be welded that requires a spot weld is a robot.

4. The system of claim 3, wherein the components of said spot welding device are affixed to a mounting plate that releasably attaches to said robot.

5. The system of claim 3, wherein said robot is used to press said weld electrode and said consumable welding spike against said parts to be welded during the spot welding process.

6. The system of claim 5, wherein said robot exerts a pressing force of between about 25-100 kgf.

7. The system of claim 1, wherein an electric, pneumatic or hydraulic cylinder is used to press said weld electrode and said consumable welding spike against said parts to be welded during the spot welding process.

8. The system of claim 5, wherein said cylinder exerts a pressing force of between about 25-100 kgf.

9. The system of claim 1, wherein said consumable welding spikes are comprised of a material that increases resistance to the passage of said electric welding current.

10. The system of claim 1, wherein said feeder system supplies said consumable welding spikes to said welding device on a carrier band.

11. The system of claim 11, wherein said carrier band is made from an electrically conducting material.

12. The system of claim 11, wherein said carrier band is made from an electrically non-conducting or substantially non-conducting material.

13. The system of claim 1, wherein said feeder system supplies said consumable welding spikes to said welding device from a vibratory bowl via a feeder tube.

14. A system for performing one-sided spot welding on parts to be welded, comprising:
a spot welding device, further comprising at least:
an electrode holder,
a weld electrode attached to said electrode holder and in communication with a source of electric welding current, and
a force regulator for regulating the amount of force exerted by said weld electrode against said parts to be welded;
a robot for moving said welding device to each location along said parts to be welded that requires a spot weld;
a supply of electrical resistance-increasing consumable welding spikes; and
a feeding system for supplying a consumable welding spike to said spot welding device prior to commencement of each spot weld;
wherein a consumable welding spike is located between said weld electrode and a surface of one of said parts to be welded prior to commencement of each spot weld; and
wherein said consumable welding spike is melted during the welding process and becomes part of the spot weld.

15. The system of claim 14, wherein the components of said spot welding device are affixed to a mounting plate that releasably attaches to said robot.

16. The system of claim 14, wherein said robot is used to press said weld electrode and said consumable welding spike against said parts to be welded during the spot welding process.

17. The system of claim 16, wherein said robot exerts a pressing force of between about 25-100 kgf.

18. The system of claim 14, wherein an electric, pneumatic or hydraulic cylinder is used to press said weld electrode and said consumable welding spike against said parts to be welded during the spot welding process.

19. The system of claim 18, wherein said cylinder exerts a pressing force of between about 25-100 kgf.

20. The system of claim 14, wherein said feeder system supplies said consumable welding spikes to said welding device on a carrier band.

21. The system of claim 20, wherein said carrier band is made from an electrically conducting material.

22. The system of claim 20, wherein said carrier band is made from an electrically non-conducting or substantially non-conducting material.

23. The system of claim 14, wherein said feeder system supplies said consumable welding spikes to said welding device from a vibratory bowl via a feeder tube.

24. A method of performing one-sided spot welding on parts to be welded, comprising:
providing a spot welding device, further comprising at least:
an electrode holder,
a weld electrode attached to said electrode holder and in communication with a source of electric welding current, and
a force regulator for regulating the amount of force exerted by said weld electrode against said parts to be welded;
using a robot to move said welding device to each location along said parts to be welded that requires a spot weld;
providing a supply of electrical resistance increasing consumable welding spikes;
employing a feeding system to supply consumable welding spikes to said spot welding device;
locating a supplied consumable welding spike between said weld electrode and a surface of one of said parts to be welded prior to commencement of each spot weld;
pressing said consumable welding spike against a surface of said parts to be welded using said weld electrode; and
supplying welding current to said weld electrode for an amount of time sufficient to produce an acceptable spot weld.

25. The method of claim 24, wherein said robot is used to press said weld electrode and said consumable welding spike against said parts to be welded during the spot welding process.

26. The method of claim 25, wherein said robot exerts a pressing force of between about 25-100 kgf.

27. The method of claim 24, wherein an electric, pneumatic or hydraulic cylinder is used to press said weld electrode and said consumable welding spike against said parts to be welded during the spot welding process.

28. The method of claim 27, wherein said cylinder exerts a pressing force of between about 25-100 kgf.

29. The method of claim 24, wherein said feeder system supplies said consumable welding spikes to said welding device on a carrier band.

30. The method of claim 29, wherein said carrier band is made from an electrically conducting material and said welding spikes are dislodged therefrom by initially passing electric current from said weld electrode through said carrier band.

31. The system of claim 29, wherein said carrier band is made from an electrically non-conducting or substantially non-conducting material and said welding spikes are forcibly dislodged therefrom prior to presentation to said weld electrode.

32. The method of claim 24, wherein said feeder system supplies said consumable welding spikes to said welding device from a vibratory bowl via a feeder tube.

33. The method of claim 24, wherein said parts to be welded are of similar composition.

34. The method of claim 24, wherein said parts to be welded are of dissimilar composition.

35. The method of claim 24, wherein said parts to be welded are of similar thickness.

36. The method of claim 24, wherein said parts to be welded are of dissimilar thickness.

37. The method of claim 24, wherein said parts to be welded are vehicular body panels.
